(19) United States
(12) Patent Application Publication
(10) Pub. No.: US 2026/0230326 A1
(43) Pub. Date: Aug. 6, 2026

(54) VERIFICATION SYSTEM, VERIFICATION METHOD, AND VERIFICATION PROGRAM

(71) Applicant: DaisyDigital Inc., Sapporo-shi Hokkaido (JP)

(72) Inventor: Joji Takatsu, Sapporo-shi Hokkaido (JP)

(73) Assignee: DaisyDigital Inc., Sapporo-shi Hokkaido (JP)

(21) Appl. No.: 19/631,237

(22) Filed: Mar. 27, 2026

Related U.S. Application Data
(63) Continuation of application No. PCT/JP2024/041019, filed on Nov. 19, 2024.

(30) Foreign Application Priority Data
Jul. 1, 2024 (JP) 2024-106450

(51) Int. Cl. H04L 9/32

(52) U.S. Cl. CPC H04L 9/3226

(57) ABSTRACT

A verification system includes: a server connected to a network; and a plurality of verification terminals and a request terminal capable of communicating with the server via the network. The request terminal transmits a request to the server for decryption of a private key of a cryptographic asset encrypted by a password, the server manages all patterns of character strings to verify the password for the request for decryption, and transmits a verification request including a different unverified character string to at least some of the verification terminals, and when the verification terminals each receive the verification request, they verify the unverified character string on the basis of the received verification request and transmits a result of verification to the server.

### CROSS-REFERENCE TO RELATED APPLICATIONS

This application is a continuation application of International Application No. PCT/JP2024/041019, filed November 19, 2024, which claims priority to Japanese Patent Application No. 2024-106450, filed July 1, 2024, each of which is incorporated herein by reference in its entirety.

### TECHNICAL FIELD

This disclosure relates to a verification system, a verification method, and a verification program that perform verification for decryption of a private key of a cryptographic asset encrypted by a password.

### BACKGROUND

Some cryptographic assets such as BITCOIN (registered trademark) employ public key cryptography, which encrypts and decrypts data using two paired keys.

For example, when transferring cryptographic assets, the remitter maintains a pair of a private key and a public key created from this private key, and encrypts the cryptographic asset address of the destination and the amount of money transferred by the private key. The encrypted information is transmitted to the remittee, where it is decrypted by the public key separately transmitted by the remitter. This allows for the remittance of cryptographic assets.

As described above, since private keys may be used to transfer cryptographic assets, the management of the private keys for cryptographic assets is considerably important. Wallets are known to be used to manage the private keys.

The wallets may have a data file format that stores private and public keys. Many of these wallets have encryption functions to prevent unauthorized transfers, for example. In the encryption of the wallets, a private key may be encrypted by a password, but if the password is lost, the cryptographic assets may be failed to be transferred, for example.

Such non-transferable cryptographic assets account for nearly 20% of the total number of bitcoins issued, for example. For this reason, wallet recovery services that restore wallets have become a hot topic. For example, non-patent document “KeychainX Succeeds in Establishing AI Recovery Algorithm for Corrupt Wallets” discloses wallet recovery services that predict passwords by AI.

However, these wallet recovery services could not adequately restore the wallets, as the percentage that could be decrypted was as low as 20%.

In contrast, if the passwords are identified by a brute force method, adequate wallet recovery can be expected, but in consideration of the number of digits in the wallet passwords, this is not realistic since the computation may need a long time.

One of the problems to be solved by this disclosure is that a password of an encrypted private key of a cryptographic asset could not be reliably identified by the brute force method.

### SUMMARY

This disclosure provides a verification system including: a server connected to a network; and a plurality of verification terminals and a request terminal capable of communicating with the server via the network. The request terminal transmits a request to the server for decryption of a private key of a cryptographic asset encrypted by a password, the server manages all patterns of character strings to verify the password for the request for decryption, and transmits a verification request including a different unverified character string to at least some of the verification terminals, and when the verification terminals each receive the verification request, they verify the unverified character string on the basis of the received verification request and transmits a result of verification to the server.

This disclosure also provides a verification method causing: a server connected to a network; and a plurality of verification terminals and a request terminal capable of communicating with the server via the network to perform the steps of: causing the request terminal to transmit a request to the server to decrypt a private key of a cryptographic asset encrypted by a password, causing the server to manage all patterns of character strings to verify the password for the request for decryption, and transmit a verification request including a different unverified string to at least some of the verification terminals, and causing each of the verification terminals, upon receiving the verification request, to perform verification on the unverified character string on the basis of the received verification request and transmit a result of the verification to the server.

Further, this disclosure provides a verification program for decryption of a private key of a cryptographic asset encrypted by a password, which program causes a computer to embody: a request receiving function of receiving, via a network from a server, a verification request that includes an unverified character string for verifying a password from among character strings for verifying the password, a verifying function of performing verification on the unverified character string on the basis of the verification request, and a result transmitting function of transmitting a result of the verification to the server.

### Advantageous Effects of the Invention

This disclosure is capable of reliably identifying a password of an encrypted private key of a cryptographic asset by a brute force method.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 shows a schematic diagram illustrating an overall structure of a verification system according to Example 1,

FIG. 2 shows a block diagram illustrating a structure of a wallet file, and

FIG. 3 shows a flowchart illustrating a verification process of a password by the verification system.

### REFERENCE SIGNS LIST

1: Verification System

3: Request Terminal

5: Server

7: Verification Terminal

400: Network

### DETAILED DESCRIPTION

Distributed computing embodies an object of reliably identifying a password of an encrypted private key of a cryptographic asset by a brute force method.

A verification system 1 includes a server 5 connected to a network 9, and a plurality of verification terminals 7 and a request terminal 3 that are capable of communicating with the server 5 via the network 9.

The request terminal 3 transmits a request to the server 5 for decryption of a private key of a cryptographic asset encrypted by a password. The server 5 manages all patterns of character strings to verify passwords for decryption requests and transmits verification requests containing different unverified character strings to at least some of the verification terminals 7. When each verification terminal 7 receives a verification request, it performs verification on the unverified character string on the basis of the received verification request and transmits the result of verification to the server 5.

The request terminal 3 may transmit a wallet file to the server 5, which wallet file contains the encrypted private key and encryption information for password encryption at the time of the decryption request. In this case, the server 5 extracts the encrypted private key and the encryption information from the wallet file, and causes the verification request to include them along with an unverified character string.

The server 5 should preferably delete the wallet file from which the encryption information has been extracted.

The request terminal 3 may transmit a cryptographic asset address of a cryptographic asset along with the wallet file to the server 5 at the time of the decryption request, and the server 5 may be able to transmit a verification request if the cryptographic asset address obtained from the wallet file is consistent with the cryptographic asset address received from the request terminal 3.

The server 5 may manage unverified character strings for each of which the result of verification is not received within a predetermined period of time from the transmission of the verification request as a request target that can be included in another verification request.

Each verification terminal 7 may be able to transmit its verification intention to the server 5. In this case, when the server 5 receives the verification intention, it transmits a verification request to the verification terminal 7 from which the verification intention has been transmitted.

The transmission of the verification intention may be performed by consuming a transmission right. The transmission right is granted, for example, in accordance with the contribution of the verification.

If the private key is successfully decrypted, the server 5 receives a reward from the cryptographic asset using the decrypted private key.

In this case, the server may allow the distribution of rewards to each user of the verification terminal in accordance with the number of verifications that the user has performed. As an embodiment, the server 5 may grant a predetermined number of points to the user of the verification terminal 7, that has performed the verification, and allow the distribution of rewards to the user of the verification terminal 7, that has performed the verification, in accordance with the ratio of points owned to the total number of points issued.

The server 5 may notify the request terminal 3 of the decrypted private key after receiving the reward.

The verification method uses the server 5, verification terminals 7, and request terminal 3. The request terminal 3 transmits a request to the server 5 for decryption of the private key of the cryptographic asset, which private key has been encrypted by a password. The server 5 manages all patterns of character strings to verify passwords in response to the decryption requests and transmits the verification requests containing different unverified character strings to at least some of the verification terminals 7. When each verification terminal 7 receives a verification request, it performs verification on the unverified character string on the basis of the received verification request and transmits the verification result to the server 5.

The verification program causes a computer to embody: a request receiving function that receives, via the network 9 from the server 5, a verification request including an unverified character string among character strings for which a password is to be verified; a verifying function that performs verification on the unverified character string on the basis of the verification request; and a result transmitting function that transmits a result of verification to the server 5.

### Example 1

### Verification System

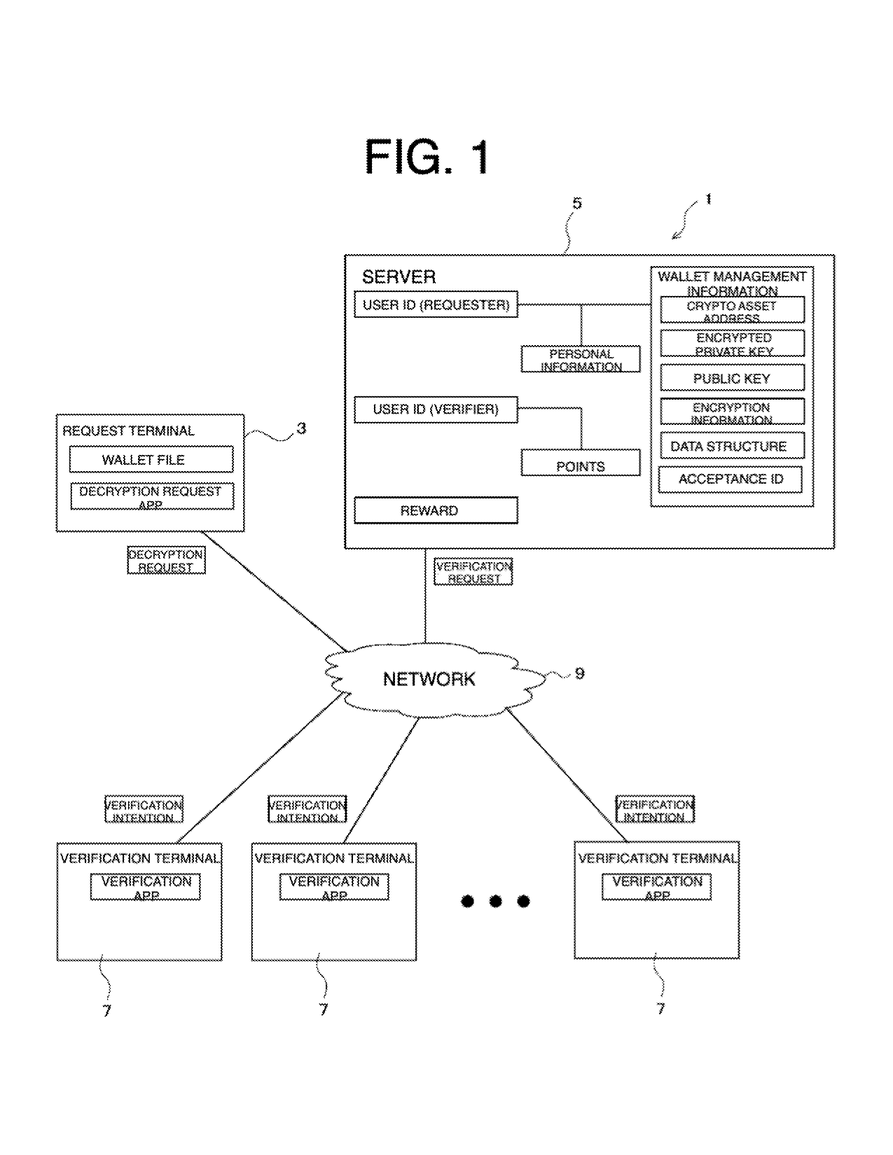

FIG. 1 shows a schematic diagram illustrating an overall structure of a verification system according to Example 1.

A verification system 1, which decrypts a private key of a cryptographic asset where the private key has been encrypted by a password, is configured by including: a request terminal 3, a server 5, and a plurality of verification terminals 7.

The request terminal 3 may correspond to a well-known computer including a processor (CPU) and memory (ROM, RAM, HDD, and SSD, for example). The request terminal 3 according to this example corresponds to a smartphone, but it may also be directed to any other mobile terminal or personal computer. The request terminal 3 is capable of communicating with other devices, for example, via the network 9 such as the Internet and telephone lines.

The request terminal 3 corresponds to a user terminal operated by a user as a requester that requests decryption of a private key, and embodies the identification requesting function, personal information registering function, and decryption requesting function by executing the decryption request application program (hereinafter, referred to as “decryption request application”) in the memory. These functions may also be embodied by the request terminal 3 accessing a website for decryption requests.

The identification requesting function may be directed to a function of requesting identification using well-known methods such as electronic know your customer (eKYC). In this identification requesting function, for example, an identification request as data containing information needed for identification, is transmitted to an eKYC service provider, for example.

The personal information registering function is embodied after the completion of identification and requests the registration of personal information such as an address, name, e-mail address, and telephone number of the requester. This registration request corresponds to data containing personal information and is transmitted to the server 5. At the server 5, the personal information is registered in response to the received registration request.

The decryption requesting function transmits a request to the server to decrypt the private key of a cryptographic asset, which private key has been encrypted by a password. The decryption request may correspond to data to request decryption of the encrypted private key.

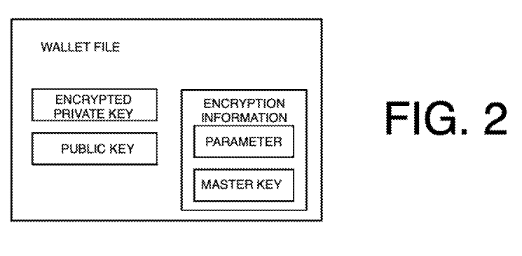

The cryptographic assets may correspond to property values represented by Bitcoin (registered trademark) and Ethereum (registered trademark) that can be electronically recorded and transferred. The cryptographic assets in this example are those in which the public key cryptosystem is employed, which may be recorded and transferred by means of a private key and a public key generated from this private key. Both the private and public keys correspond to data used to control the procedures of the encryption algorithm. The wallet file corresponds to a data file that stores these private and public keys. FIG. 2 shows an example of the wallet file.

In this example, the private key is encrypted, and the wallet file stores this encrypted private key, public key (cryptographic asset address), as well as encryption information.

The cryptographic asset address corresponds to a character string generated from the public key and functions like an account number. The encryption information corresponds to information such as parameters and a master key used for encryption. The master key corresponds to data that controls a procedure of the encryption algorithm of the private key and is encrypted by a password. Accordingly, the private key is indirectly encrypted by the password. The parameters of the encryption information include parameters for encryption by password and parameters for encryption by master key. The private key may be encrypted directly by the password.

The decryption requesting function in this example transmits the cryptographic asset address of the separately accepted cryptographic asset along with the wallet file to the server 5 at the time of transmitting the decryption request. The separate acceptance of the cryptographic asset address is performed through the user interface of the request terminal 3 or other means.

The server 5 corresponds to a well-known computer including a processor and memory. In FIG. 1, only one server 5 is shown, but it is preferable to configure the system with multiple servers 5. The server 5 executes programs in the memory to embody a user managing function, request accepting function, verification requesting function, reward managing function, and result processing function.

The user managing function manages each user of the request terminals 3 and the verification terminals 7. This management is performed on the basis of, for example, a user ID for each user set in advance from the request terminal 3 and the verification terminal 7. This user managing function associates and manages personal information received from the request terminal 3 and other necessary information with the user ID.

When the request accepting function receives a decryption request from the request terminal 3, it is allowed to transmit a verification request if the cryptographic asset address obtained from the wallet file and the cryptographic asset address received from the request terminal 3 are consistent with each other. The cryptographic asset address obtained from the wallet file means the cryptographic asset address generated and obtained from the public key stored in the wallet file. If the cryptographic asset address is maintained in the wallet file, this cryptographic asset address may also be obtained directly.

To enable the transmission of the verification request, the request accepting function issues an acceptance ID in response to the decryption request and also constructs a data structure that covers all patterns of character strings to verify the passwords for decryption of the private keys. This data structure may be able to manage all patterns of character strings for verifying passwords for decryption of private keys. The acceptance ID is notified to the request terminal 3 when the construction of the data structure is completed.

The request accepting function extracts the encrypted private key and encryption information from the wallet file. The wallet file from which the encryption information is extracted is deleted and is not retained on the server 5.

The cryptographic asset address, encrypted private key, public key, encryption information, and constructed data structure obtained from the wallet file, as well as the acceptance ID, are associated with the user ID of the user as a requester by the user managing function and managed as wallet management information.

The verification requesting function transmits a verification request containing a different unverified character string to at least some of the multiple verification terminals 7. The verification request corresponds to data to request verification of an unverified character string. The verification request in this example includes the encrypted private key, encryption information, public key (cryptographic asset address), and acceptance ID along with the unverified character string.

The management of the character strings manages unverified, pending verification requests, verified, or decrypted for character strings. The character string for a pending verification request is managed as “Unverified” if the result of the verification is not received within a predetermined period of time from the transmission of the verification request. That is, the unverified character string for which the result of verification is not received within a predetermined period of time from the transmission of the verification request is managed as a request target that can be included in another verification request.

The verification request is transmitted to the verification terminal 7 from which the verification intent is transmitted in response to the receipt of the verification intent. However, the verification request may be transmitted to multiple verification terminals 7 simultaneously or randomly independent of the verification intention.

If the private key is successfully decrypted, the reward managing function receives the reward from the cryptographic asset of the requester using the decrypted private key. That is, a cryptographic asset address for reward is prepared, and the reward is transferred from the cryptographic asset address of the requester to this cryptographic asset address for the reward and pooled.

The reward managing function enables the distribution of rewards to multiple verification terminals 7 in accordance with the number of verifications performed, respectively. In this example, the verification terminals 7 are given a predetermined number of points for each number of verifications performed. The reward can then be distributed to the multiple verification terminals 7 that have performed the verification in accordance with the percentage of points owned to the total number of points issued. The points are associated with the user IDs and managed by the user managing function.

The result processing function receives the result of verification from the verification terminal 7 that has performed the verification. The verification result corresponds to data showing the result of the verification on the unverified character string. The result processing function causes the character string described above to be managed on the basis of the received verification result. This result processing function notifies the request terminal 3 of the decrypted private key after receiving the reward.

The multiple verification terminals 7 are each a well-known computer with a processor and memory. The verification terminals 7 according to this example each correspond to a smartphone, but they may also be directed to any other mobile terminal or personal computer. The verification terminals 7 are each capable of communicating with other devices, for example, via the network 9 such as the Internet or telephone lines.

These verification terminals 7 are each directed to a user terminal operated by the user that verifies the password, and embodies the request receiving, verifying, and result transmitting functions by executing the application program for verification (hereinafter referred to as “verification application”) in memory.

The request receiving function receives, via the network 9 from the server 5, the verification request containing an unverified character string from among the character strings for which the password is to be verified. In this example, the request receiving function transmits the verification intention to the server 5 and receives the verification request transmitted from the server 5 in response to the verification intention.

The verification intention is directed to data indicating the intention to perform the verification, and may be accepted, for example, by selecting a button on the user interface of the verification terminal 7. The transmission of the verification intention is performed by consuming the transmission right. The transmission right is granted in accordance with the contribution of the verification, such as the results of verifications that have already been performed and the total number of verifications. The transmission right may also be purchased through the verification terminal 7.

When the verifying function receives a verification request from the server 5, it performs verification on the unverified character string on the basis of this received verification request. The verification methods will be described below for which well-known methods can be used.

The result transmitting function transmits the success or failure of the decryption of the private key for the verified character string to the server 3 as the result of the verification.

### Verification Process

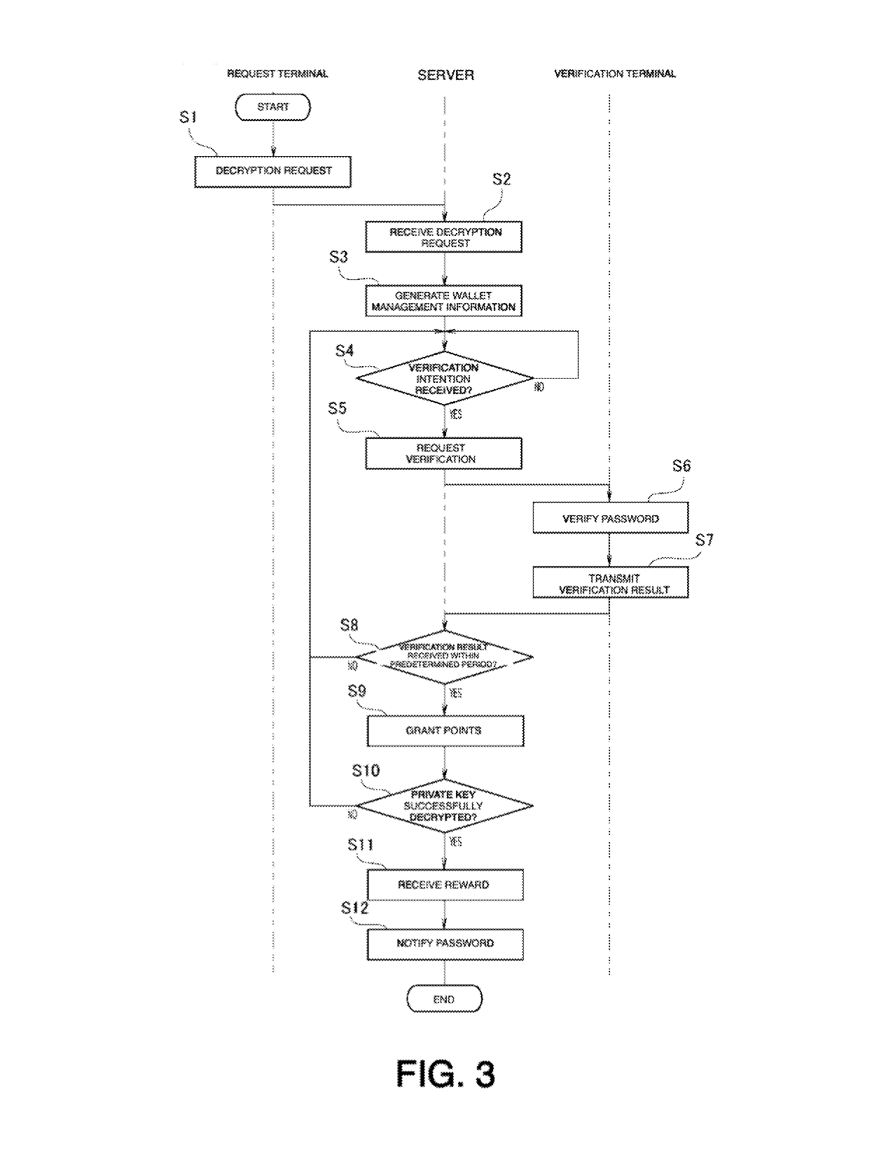

FIG. 3 shows a flowchart illustrating a verification process of a password by the verification system 1.

At the time of verifying the password, first, in step S1, a request for decryption of the encrypted private key is performed from the verification terminal 7. At the time of the request for decryption, a cryptographic asset address of the cryptographic asset accepted on the user interface of the verification terminal 7, for example, is transmitted to the server 5 along with a wallet file containing the encrypted private key.

The verification terminal 7 that performs the decryption request should have completed identification and personal information registration in advance. This prevents unauthorized decryption requests.

In step S2, the decryption request is accepted at the server 5. That is, when the server 5 receives the decryption request, it checks whether the cryptographic asset address contained in the received decryption request is consistent with the cryptographic asset address obtained from the wallet file.

If both the cryptographic asset addresses are consistent with each other, the decryption request is determined to be reasonable and step S3 is executed. In contrast, if both the cryptographic asset addresses are not consistent with each other, the server 5 determines that the decryption request is not reasonable and the process is terminated.

In step S3, wallet management information is generated at the server 5. That is, the server 5 extracts parameters and encrypted master key as well as encrypted private and public keys from the wallet file as encryption information. The wallet file from which the extraction has been performed is deleted from the server 5. Further, the server 5 issues an acceptance ID for the decryption request, and also constructs a data structure that covers all patterns of character strings for verifying the passwords used for decryption of the private keys. As for the generation of wallet management information, information extracted from the data structure and wallet file is associated with the acceptance ID. The acceptance ID is notified to the request terminal 3 when the construction of the data structure is completed.

In step S4, whether the verification intention has been received at the server 5 is determined. The verification intention is performed by consuming the transmission right through an operation on the verification terminal 7. If the verification intention is received (YES), a verification request is transmitted to the verification terminal 7 from which the verification intention has been transmitted in step S5. If the server 5 does not receive the verification intention (NO), the process will not proceed from step S4.

At the time of the verification request, a character string with the status “Unverified” is extracted from the character strings managed by the server 5. The character string to be extracted may be directed to a character string in accordance with the condition, if any, specified in the verification intention, or a random character string if none is specified. The extracted character string is contained in the verification request with the status updated from “Unverified” to “Verification Request Pending.” The verification request includes the encrypted private key, encryption information, public key (cryptographic asset address), and acceptance ID along with the unverified character string.

In step S6, the password is verified at the verification terminal 7. That is, the verification terminal 7 that receives the verification request performs verification on the unverified character string included in the received verification request.

The verification in this example attempts to decrypt the master key of the encryption information by referring to the parameters, for example, of the encryption information by means of an unverified character string included in the verification request. When the master key is decrypted, the private key is decrypted by referring to the parameters, for example, of the encryption information, and the public key (cryptographic asset address) is generated from the decrypted private key. If the public key (cryptographic asset address) generated here is consistent with the public key (cryptographic asset address) included in the verification request, it is recognized that the private key has been successfully decrypted.

If the master key is omitted and the private key is encrypted directly by password, the private key is decrypted in place of the master key, and the public key (cryptographic asset address) may be generated from this decrypted private key in the same manner as above.

In step S7, the verification result is transmitted from the verification terminal 7. That is, the verification terminal 7 that has performed the verification transmits the success or failure of the decryption of the private key for the verified character string to the server as the result of the verification along with the acceptance ID.

In step S8, the server 5 determines whether the verification result has been accepted within a predetermined period of time. That is, the server 5 determines whether the verification result is received from the verification terminal 7 within a predetermined period of time from the transmission of the corresponding verification request.

If the verification result is received within the predetermined period of time (YES), the server 5 reflects the verification result on the wallet management information on the basis of the acceptance ID. That is, the status of the verified character string is updated to “Verified” or “Decrypted.” The process then moves to step S9.

If the result of the verification is not received within the predetermined period of time (NO), the server 5 determines that the verification corresponding to the verification request has failed and returns the status of the unverified character string contained in the verification request to “Unverified” from “Verification Request Pending.” The process then returns to step S4.

In step S9, points are awarded. That is, the server 5 awards points to the user of the verification terminal 7, that has performed the verification, in accordance with the number of verifications performed. In addition to the awarding of points, in this example, various items and bonus points, including transmission rights, are awarded in accordance with the contribution level of the verification, such as the results of verifications already performed and the total number of verifications. The items and bonus points are recognized on the verification application of the verification terminal 7, and registration is operated by the user.

In step S10, whether the private key has been decrypted is determined. That is, the server 5 refers to the wallet management information to determine whether the decryption has been performed on the private key. If the decryption is performed, the reward is received in step S11. In contrast, if the decryption has not been performed, the process returns to step S4.

To receive the reward, the server 5 uses the decrypted private key to transfer the reward from the corresponding cryptographic asset. It is preferable to cause the request terminal 3 to perform prior authorization for the remittance. For example, the server 5 notifies the request terminal 3 of the completion of the decryption and accepts confirmation of remittance of the reward on the request terminal 3. The remittance destination may be the cryptographic asset address for receiving the reward, which is managed by the server 5.

The rewards received by the server 5 are pooled to allow distribution of the rewards to multiple users of the verification terminals 7, that have performed the verification, in accordance with the percentage of points owned to the total number of points issued. The distribution destination of the reward may be set to the cryptographic asset address temporarily associated with the user ID and registered. For example, for the distribution of the reward, the user is caused to request from the verification terminal 7, and at that time, to enter a cryptographic asset address.

In step S12, the password is notified. That is, the server 5 notifies the request terminal 3 of the password with the private key (master key) decrypted after the user receives the reward.

As described above, the verification system 1 according to this example includes a server 5 connected to a network 9, and a plurality of verification terminals 7 and a request terminal 3 that are capable of communicating with the server 5 via the network 9. The request terminal 3 transmits a request to the server 5 for decryption of the private key of the cryptographic asset encrypted by the password, the server 5 manages all patterns of character strings to verify the password for the decryption request and transmits verification requests including different unverified character strings to at least some of the multiple verification terminals 7, and when each of the verification terminals 7 receives a verification request, it performs verification on the unverified character string on the basis of this received verification request and transmits the result of the verification to the server 5.

Therefore, in this example, the password of the encrypted private key of the cryptographic asset may be reliably identified by a brute force method through distributed computing that allows multiple verification terminals 7 to verify different unverified character strings.

The request terminal 3 transmits, at the time of the decryption request, a wallet file that contains the encrypted private key and the encryption information for encryption by the password to the server 5, and the server 5 extracts the encrypted private key and encryption information from the wallet file and includes them along with the unverified character string in the verification request.

This allows, in this example, the password to be more easily and reliably verified.

The server 5 deletes the wallet file from which the encryption information has been extracted. This improves security.

The request terminal 3 transmits the cryptographic asset address of the cryptographic asset along with the wallet file to the server 5 at the time of the decryption request, and the server 5 is allowed to transmit a verification request if the cryptographic asset address obtained from the wallet file is consistent with the cryptographic asset address received from the request terminal 3.

This allows the verification requests to be transmitted only for reasonable decryption requests.

The server 5 manages an unverified string for which the result of verification is not received within a predetermined period of time from the transmission of the verification request as a request target that can be included in another verification request. Accordingly, this example can more reliably achieve a brute-force password verification.

Each of the multiple verification terminals 7 can transmit a verification intention to the server 5, and when the server 5 receives the verification intention, it transmits a verification request to the verification terminal 7 from which this verification intention has been transmitted.

This, in this example, reduces the processing loads on the server 5 at the time of transmitting the verification request since the verification request only needs to be transmitted in response to the verification intent. This also limits, in the verification terminals 7, the loads on processing capacity due to unintended verification requests.

The transmission of the verification intention is performed by consuming the transmission right, and the transmission right may be granted in accordance with the contribution of the verification. This limits the transmission of the verification intention unnecessarily.

If the private key is successfully decrypted, the server 5 receives a reward from the cryptographic asset using the decrypted private key. This facilitates, in this example, the server 5 to receive and pool rewards.

In this example, the pooled rewards may then be distributed to multiple users of the verification terminals 7, that have performed the verification, in accordance with the number of verifications performed. Especially, in this example, a predetermined number of points are awarded to each user of the verification terminal 7, that has performed the verification, and the rewards can be distributed in accordance with the ratio of the points owned to the total number of points issued.

This allows, in this example, the rewards to be easily and reliably distributed.

The server 5 notifies the request terminal 3 of the password that is capable of decrypting the private key after receiving the reward. Accordingly, the decryption process, which is completed by notifying the password to the request terminal 3, may include the receipt of the reward.

What is claimed is:

1. A verification system comprising:
a server connected to a network; and
a plurality of verification terminals and a request terminal capable of communicating with the server via the network, wherein
the request terminal transmits a request to the server for decryption of a private key of a cryptographic asset encrypted by a password,
the server manages all patterns of character strings to verify the password for the request for decryption, and transmits a verification request including a different unverified character string to at least some of the verification terminals, and
when the verification terminals each receive the verification request, they verify the unverified character string on the basis of the received verification request and transmits a result of verification to the server.

2. The verification system according to claim 1, wherein
the request terminal transmits, to the server, a wallet file that contains the encrypted private key and encryption information for encryption by the password at the time of the request for decryption, and
the server extracts the encrypted private key and the encryption information from the wallet file and includes them along with the unverified character string in the verification request.

3. The verification system according to claim 2, wherein the server deletes the wallet file from which the encryption information has been extracted.

4. The verification system according to claim 2, wherein
the request terminal transmits a cryptographic asset address of the cryptographic asset along with the wallet file to the server at the time of the request for decryption, and
the server is allowed to transmit the verification request if the cryptographic asset address obtained from the wallet file is consistent with the cryptographic asset address received from the request terminal.

5. The verification system according to claim 1, wherein the server manages an unverified character string for which the result of verification is not received within a predetermined period of time from the transmission of the verification request as a request target capable of being included in another verification request.

6. The verification system according to claim 1, wherein
the verification terminals are each capable of transmitting verification intention to the server, and
when the server receives the verification intention, it transmits the verification request to the verification terminal from which the verification intention has been transmitted.

7. The verification system according to claim 6, wherein
the transmission of the verification intention is performed by consuming a transmission right, and
the transmission right is granted in accordance with a contribution level of the verification.

8. The verification system according to claim 1, wherein the server receives, if the private key is successfully decrypted, a reward from the cryptographic asset using the decrypted private key.

9. The verification system according to claim 8, wherein the server is capable of distributing the reward to each of the users of the verification terminals in accordance with a number of the verification performed.

10. The verification system according to claim 9, wherein the server grants a predetermined number of points to the user of the verification terminal that has performed the verification, and enables the distribution of the reward to the user of the verification terminal, that has performed the verification, in accordance with a ratio of points owned to a total number of the points issued.

11. The verification system according to claim 8, wherein the server notifies the request terminal of the password that is capable of decrypting the private key after receiving the reward.

12. A verification method causing:
a server connected to a network; and
a plurality of verification terminals and a request terminal capable of communicating with the server via the network to perform the steps of:
causing the request terminal to transmit a request to the server to decrypt a private key of a cryptographic asset encrypted by a password,
causing the server to manage all patterns of character strings to verify the password for the request for decryption, and transmit a verification request including a different unverified string to at least some of the verification terminals, and
causing each of the verification terminals, upon receiving the verification request, to perform verification on the unverified character string on the basis of the received verification request and transmit a result of the verification to the server.

13. A non-transitory computer readable medium storing therein a verification program for decryption of a private key of a cryptographic asset encrypted by a password, the program causing a computer to embody:
a request receiving function of receiving, via a network from a server, a verification request that includes an unverified character string for verifying a password from among character strings for verifying the password,
a verifying function of performing verification on the unverified character string on the basis of the verification request, and
a result transmitting function of transmitting a result of the verification to the server.
